(19) United States
(12) Patent Application Publication
(10) Pub. No.: US 2018/0142736 A1
(43) Pub. Date: May 24, 2018

(54) Rotor Cup and an Open-End Spinning Rotor with a Rotor Cup

(71) Applicant: Maschinenfabrik Rieter AG, Winterthur (CH)

(72) Inventors: Markus Kuebler, Geislingen (DE); Bernd Loos, Deggingen (DE); Constantin Rieger, Gingen (DE)

(21) Appl. No.: 15/818,851

(22) Filed: Nov. 21, 2017

(30) Foreign Application Priority Data
Nov. 23, 2016 (DE) 10 2016 122 595.9

(51) Int. Cl. F16D 1/116

(52) U.S. Cl. CPC F16D 1/116

(57) ABSTRACT

A rotor cup for spinning a fiber material includes a coupling device to detachably connect the rotor cup to a rotor shaft. The coupling device includes a connecting means for transfer of torque from the rotor shaft to the rotor cup and for axial securing of the rotor cup on the rotor shaft, and a centering means for centering the rotor cup on the rotor shaft. The centering means may include a cone-shaped extension or cone-shaped receiver defined on the rotor cup. The connecting means may include an extension on the rotor cup, with the centering means being a centering element separate from the connecting means and defined as one of a cylinder pin fixed in the rotor cup or a centering bore arranged in the rotor cup. An open end spinning rotor may include the rotor cup.

### FIELD OF THE INVENTION

The present invention relates to a rotor cup in which a fiber material can be spun, and a coupling device for a detachable connection of the rotor cup to a rotor shaft provided. The coupling device comprises at least one connecting means for the transfer of torque from the rotor shaft provided to the rotor cup and for the axial securing of the rotor cup on the rotor shaft. At least one centering means is provided for centering the rotor cup on the rotor shaft.

Furthermore, the invention relates to an open-end spinning rotor with a rotor cup, in which a fiber material can be spun, and with a rotor shaft, by means of which the spinning rotor can be supported in a bearing, in particular a magnetic bearing, whereas the rotor shaft and the rotor cup are detachably connected to one another by means of a coupling device. Whereas the coupling device comprises connecting means for the transfer of torque between the rotor cup and the rotor shaft and for the axial securing of the rotor cup on the rotor shaft and centering means for centering the rotor cup and rotor shaft.

### BACKGROUND

From the state of the art, connecting a rotor cup and a rotor shaft to an open-end spinning rotor is sufficiently known. Such spinning rotors run with rotor speeds of 150,000 rpm and higher, which is why the connection between the rotor cup and the rotor shaft must be extremely reliable. In addition to the high degree of support of the rotor cup in the rotor shaft, the highest precision is required to maintain the yarn quality, which is why the spinning rotors or the rotor cups have to be changed after a certain running time. However, particularly in the case of non-contact bearings, replacing the entire spinning rotor with the rotor shaft is costly, such that it is frequently the case that the rotor cups are detachably connected to the associated rotor shaft.

A proposal for the implementation of a detachable connection is described in EP 1 156 142 B1. In this, the rotor cup features a ferromagnetic attachment from which one section serves the purpose of centering, and a second section is provided with an outer polygon for the transfer of torque. A permanent magnet serves the purpose of axial securing. The production of the rotor cup with the two-piece attachment with the outer polygon and the rotor shaft with the corresponding inner polygon is comparatively complex.

A further development of the coupling device described above is shown in EP 2 730 686 B1. In this, the centering between the rotor shaft and the rotor cup is to be improved by providing a clearance fit between a cylindrical bore of the rotor shaft and the section of the attachment of the rotor cup serving the purpose of centering. Furthermore, an elastic arrangement is to be provided between the bore and the cylindrical section.

### SUMMARY OF THE INVENTION

A task of the present invention is to propose a rotor cup along with an open-end spinning rotor, which can be produced easily and enables a good centering of the rotor cup on the rotor shaft. Additional objects and advantages of the invention will be set forth in part in the following description, or may be obvious from the description, or may be learned through practice of the invention.

The tasks are solved with the characteristics of the invention described and claimed herein.

A rotor cup in which a fiber material can be spun is proposed. The rotor cup features a coupling device for a detachable connection to a rotor shaft provided for it. The coupling device comprises at least one connecting means for the transfer of torque from the rotor shaft to the rotor cup. The transfer of torque between the rotor cup and the rotor shaft preferably takes place by means of a positive-locking connection. The rotor cup is arranged in a manner protected against rotation with respect to the rotor shaft, such that a rotational relative movement is prevented between such two components. Furthermore, the coupling device comprises at least one connecting means for the axial securing of the rotor cup on the rotor shaft, which can be formed as a single piece with or separately from the connecting means for the transfer of torque. The rotor cup is fixed by the at least one connecting means with maximum hold on the rotor shaft. In addition, the coupling device comprises at least one centering means for centering the rotor cup on the rotor shaft.

According to a first design of the rotor cup, the centering means comprises a cone-shaped extension or a cone-shaped receiver on the rotor cup. The extension is preferably formed on the rotor cup and the receiver is preferably formed on the rotor shaft. The extension corresponds to the receiver in the form of a conical bore, such that the rotor cup is centered on the rotor shaft if such two components are connected to one another. The extension of the rotor cup can be detachably inserted into the receiver of the rotor shaft. The rotor cup and the rotor shaft cooperate with one another through the extension inserted into the receiver. The extension and the receiver are preferably cone-shaped, with a cone angle of 10° to 30°. The cone angle, in particular its angle of inclination, is selected in such a manner that it is not self-locking, such that the connection is easily detachable at any time. The cone-shaped receiver or the cone-shaped extension effect a particularly good centering of the rotor cup on the rotor shaft, and can nevertheless be produced in a comparatively simple manner, for example, by turning.

Particularly in the case of a rotor cup with a cone-shaped extension or a cone-shaped receiver, it is advantageous if the extension features an attachment or the receiver features a recess. The attachment or the recess is preferably formed to be rotationally symmetrical, in particular cylindrical. With this, the attachment can serve the purpose of both the improved guidance of the rotor cup on the rotor shaft. However, the attachment can also enable the integration of additional functions without impairing the centering or the conical seat. For example, the attachment can be formed in one or multiple edges, in order to be able to cooperate with a corresponding recess of the rotor shaft, which is likewise formed in one or multiple edges. As a result, additional anti-rotation protection of the rotor cup is provided with respect to the rotor shaft for the transfer of torque, while the cone-shaped extension or the cone-shaped receiver serves the purpose of centering.

If the extension is designed in a cone shape, it is also advantageous if the cone-shaped extension features a ring-shaped circumferential elevation, in particular a bulge. Owing to production tolerances, it is frequently the case that the cone-shaped extension and the corresponding cone-shaped receiver feature a slightly different angle of inclination. Since, with the connection between the rotor cup and the rotor shaft, only small axial clamping forces can be applied, such production tolerances cannot be compensated for by an elastic deformation of the extension and the associated receiver, such that throughout the length of the extension it can come into contact only at a ring-shaped line or a very short cylindrical area. Here, the length of the extension is understood as the spread of the extension in the direction of its axis of rotation, and thus in the direction of the axis of the spinning rotor or of the rotor cup and of the rotor shaft. This can be counteracted by the bulge, since the bulge is more easily elastically deformable at lower forces and thus creates a defined contact area.

Preferably, the elevation is arranged in an area of the extension turned towards the rotor cup or a rotor base of the rotor cup; that is, in relation to a length of the extension, the elevation is arranged closer to the beginning of the extension that adjoins the actual rotor cup or the rotor base than at the end of the extension. The contact area, which is defined by the elevation, is thereby advantageously located close to the actual rotor cup or the rotor base. Thus, the unsupported part of the rotor cup projecting out of the receiver is shorter, which results in better support of the rotor cup in the rotor shaft.

With a rotor cup with a cone-shaped extension or a cone-shaped receiver, it is further advantageous if the centering means and the connecting means are formed, at least partially, in one piece with one another. The one-piece design of the centering means or the connecting means enables a very precise and, at the same time, cost-effective production of the rotor cup. The means necessary for the connection, such as, for example, grooves or toothings, are formed directly on the centering means, thus on the cone-shaped extension or the cone-shaped receiver. Therefore, different sections need not be provided on the extension or the receiver; rather, both functions can also be realized in a single section.

According to an alternative design of the rotor cup, the centering means comprises at least one centering element, which is formed separately from the connecting means. The centering element comprises a cylinder pin fixed in the rotor cup or a centering bore arranged in the rotor cup for receiving a cylinder pin of the rotor shaft. The connecting means comprises a preferably cylindrical extension on the rotor cup. The extension corresponds to a receiver of the rotor shaft. With this, the centering of the rotor cup and its torque-transferring and/or axially securing connection to the rotor shaft takes place by means of various components, namely the separate cylinder pin along with the extension formed on the rotor cup. The arrangements or means, such as, for example, grooves, toothings or the like, necessary for the axially securing and/or torque-transferring connection are arranged separately from the centering means on a separate component. The centering is effected directly by means of the cylinder pin. This also ensures a very precise connection of the rotor cup with the rotor shaft, and creates cost-effective production, since the cylinder pins can be sourced as standard parts. Since the connecting means is completely separate from the centering means, this cannot adversely affect the centering of the rotor shaft and the rotor cup. At the same time, the establishment of the connecting means at the rotor cup and on the rotor shaft is facilitated, since this can be carried out at any desired location and in any manner, independently of the centering means.

Advantageously, the extension is formed in one piece on the rotor cup. Thereby, the production of the rotor cup is achievable in a few steps. Furthermore, the connecting means thereby withstands very high forces. This design is therefore advantageous both for a cone-shaped extension and for an extension that is formed cylindrically or in another shape.

It is further advantageous if the cylinder pin is fixed (in particular, pressed) into the rotor cup. In order to compensate for the air pressure when introducing the cylinder pin of the rotor cup into the cylinder bore of the rotor shaft, it is additionally advantageous if the cylinder pin features a pressure compensation bore. The pressure compensation bore preferably extends through the entire length of the cylinder pin. If the cylinder pin is pressed into the rotor cup, the rotor cup preferably features a bore adjacent to the pressure compensation bore of the cylinder pin. When the rotor cup and the rotor shaft are joined together, the pressure is compensated for by the air exiting through the pressure compensation bore.

It constitutes an advantage if the receiver of the rotor cup features a first circumferential groove of the rotor cup or if the extension of the rotor cup features a second circumferential groove. A securing element for the axial securing of the rotor cup at the rotor shaft can then be inserted into it. Correspondingly, it is also advantageous if a securing element for the axial securing of the rotor cup on the rotor shaft is inserted, as a connecting means, into the first circumferential groove of the receiver or into the second circumferential groove of the extension. Alternatively, the circumferential groove can cooperate with a securing element arranged on the rotor shaft.

The securing element is preferably an O-ring or a snap ring. The securing element is preferably made of an elastomeric material. Vulcanizates of natural rubber and synthetic rubber are also conceivable as materials for the securing element. Alternatively, however, an axial securing of the rotor cup by means of a magnet can also be realized, as in the state of the art. If the rotor cup and the rotor shaft are connected to one another, the O-ring is pressed into the respective circumferential grooves of the rotor cup and the rotor shaft, by which at least an axial securing is possible.

It is advantageous if the securing element is a snap ring made of spring steel. The snap ring is formed from a spring steel wire, which is bent into a ring. The ends of the spring steel wire are usually at least slightly spaced from one another, such that the circumference of the snap ring is not completely closed. The snap ring is preferably arranged on the rotor cup, such that the rotor cup, when driven, is pulled into the receiver. The receiver comprises an inclined groove flank, into which the snap ring is pulled when the rotor cup is driven. For the use of the snap ring, either the rotor cup or the rotor shaft features a circumferential groove for receiving the snap ring. The respective other component preferably also features a circumferential groove with an inclined groove flank. By means of the snap ring, it is possible to realize high axial forces. Furthermore, the axial support is extremely strong. The snap ring transfers the axial forces acting on the inclined groove flank.

Alternatively, it is advantageous if the securing element is an O-ring made of an elastomeric material. The O-ring is preferably used if there is a clearance between the rotor cup and the rotor shaft that is compensated for by the O-ring. The two circumferential grooves are axially slightly offset relative to each other if the rotor cup and the rotor shaft are connected to one another. As a result, the O-ring arranged on the rotor cup pulls the rotor cup in an axial manner into the receiver of the rotor shaft.

The first circumferential groove of the receiver advantageously features an inclined groove flank. The securing element located in the groove, which is in particular formed as a snap ring or O-ring, widens during operation, due to the high rotational speed of the spinning rotor, and presses against the inclined groove flank. In particular with a coupling device with a conical extension, the rotor shaft and the rotor cup are thereby pulled together even further, such that, thereby, the axial securing between the rotor cup and the rotor shaft provided for it is further improved.

Advantageously, the securing element serves the purpose of, at the same time, transferring the torque from the rotor shaft to the rotor cup. By means of the securing element, a force-fitting connection for anti-rotation protection is formed between the rotor shaft and the rotor cup. Thereby, the production effort can be reduced, since a component takes over several functions.

As an alternative or in addition to the above-described force-fitting connection for anti-rotation protection, it is advantageous if the extension or the receiver features at least one form closure element and forms a positive-locking connection for the transfer of torque from the rotor shaft to the rotor cup. The form closure element is, for example, a claw-type coupling, but can also feature any other shape suitable for the transfer of torque. Thereby, the transfer of torque between the rotor shaft and the rotor cup is highly reliable.

It constitutes an advantage if the at least one form closure element of the extension is arranged on the cylindrical attachment, or if the at least one form closure element of the receiver is arranged in the recess.

In addition, an open-end spinning rotor with a rotor cup, in which a fiber material can be spun, and a rotor shaft, are proposed. By means of the rotor shaft, the spinning rotor can be supported in a bearing, in particular in a magnetic bearing. The rotor shaft and the rotor cup are detachably connected to one another by means of a coupling device. The coupling device comprises connecting means for the transfer of torque between the rotor cup and the rotor shaft and for the axial securing of the rotor cup on the rotor shaft. Furthermore, the coupling device comprises centering means for centering the rotor cup and the rotor shaft.

According to a first embodiment, the centering means comprises a cone-shaped extension on one of the two components (rotor cup or rotor shaft), along with a cone-shaped receiver in the respective other component, into which the extension can be detachably inserted. The extension is preferably formed in one piece with the component that includes the extension. As already described for the rotor cup, the cone angle is preferably 10° to 30° and is selected in such a manner that it is not self-locking. Thereby, a particularly good centering between the rotor cup and the rotor shaft can be achieved and, at the same time, a cost-effective production of the spinning rotor is enabled. With this, the extension is preferably formed on the rotor cup and the receiver is formed on the rotor shaft, but a reverse arrangement is also conceivable.

It is advantageous if the extension features an attachment and the receiver features a recess, which are preferably formed to be rotationally symmetrical, in particular cylindrical. As already described, the attachment can serve the purpose of both the improved guidance of the rotor cup on the rotor shaft and the realization of additional functions of the coupling device, for example the transfer of torque, independently of the tapered connection.

It is further advantageous if the centering means and the connecting means are formed, at least partially, in one piece with one another. The means necessary for the connection, such as, for example, grooves, toothings or the like, are preferably formed directly on the centering means or set of centering means, in particular on the cone-shaped attachment and/or the cone-shaped receiver.

Alternatively, the centering means comprises at least one centering element formed separately from the connecting means. The centering element comprises a cylinder pin, which is fixed (in particular, pressed) into one of the two components (rotor cup or rotor shaft). The cylinder pin can be detachably inserted into a centering bore of the respective other component, which forms a centering means on the respective other component. Furthermore, the connecting means comprises a preferably cylindrical extension on the rotor cup and a preferably cylindrical receiver on the rotor shaft, into which the extension of the rotor cup can be inserted. Thus, the centering means and the connecting means are provided by various components, whereas the centering is effected through the cooperation of the cylinder pin and the centering bore, while the connection (that is, the axial securing and/or the transfer of torque) between the rotor cup and the rotor shaft is effected through the continuation of the rotor cup along with the receiver of the rotor shaft. Possible arrangements for additional connecting means such as grooves, toothings or the like are not undertaken on the centering means, but on the extension, such that the functions of centering and connecting are provided on separate components. The production of the open-end spinning rotor is simplified by the cylinder pin. Problems of fitting are also reduced.

It is also advantageous if the extension and/or the receiver are connected in one piece to the rotor shaft or the rotor cup. In principle, however, it would also be possible to provide the extension and/or the receiver as separate components and then connect them to the rotor shaft or to the rotor cup.

Advantageously, the cylinder pin is fixed (in particular, pressed) into the rotor shaft. The cylinder pin is thereby arranged in a manner protected against damage.

It is advantageous if the centering means and the connecting means are formed, at least partially, in one piece with one another. This enables a highly cost-effective production of the spinning rotor, since the two functions of centering and connecting can be realized on a single component and also in a single section of the same component.

Advantageously, the open-end spinning rotor features a rotor cup in accordance with the preceding description.

### BRIEF DESCRIPTION OF THE DRAWINGS

Further advantages of the invention are described in the following embodiments. The following is shown:

FIG. 1 is a first design of a rotor cup in accordance with the invention and an associated rotor shaft;

FIG. 2 is an open-end spinning rotor with a rotor cup in accordance with the first design;

FIG. 3 is a second embodiment of the rotor cup and the rotor shaft provided for it;

FIG. 4 is a third design of the rotor cup and the associated rotor shaft;

FIG. 5 is an open-end spinning rotor with the rotor cup and the rotor shaft in accordance with a fourth design;

FIG. 6 is a fifth embodiment of the rotor cup and the associated rotor shaft;

FIG. 7 is the open-end spinning rotor with the rotor cup and the rotor shaft in accordance with the fifth embodiment, in sections;

FIG. 8 is a sixth embodiment of the rotor cup and the associated rotor shaft;

FIG. 9 is a seventh embodiment of the rotor cup and the associated rotor shaft;

FIG. 10 is an eighth embodiment of the rotor cup and the associated rotor shaft;

FIG. 11 is a ninth embodiment of the rotor cup and the associated rotor shaft;

FIG. 12 is a tenth embodiment of the rotor cup and the associated rotor shaft;

FIG. 13 is the rotor cup with a claw coupling in accordance with the fifth embodiment; and

FIG. 14 is an additional embodiment of the rotor cup and the rotor shaft provided for it.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

FIG. 1 shows a rotor cup 1 in accordance with the invention and a rotor shaft 2 provided for connection to the rotor cup 1, which is shown broken away in all of the figures. The rotor cup 1 features a first part 3 of a coupling device 4 for detachably connecting the rotor cup 1 to the rotor shaft 2. The rotor shaft 2 features a second part 5 of the coupling device 4 for the connection to the rotor cup 1. The two parts 3, 5 of the coupling device 4 comprise connecting means 6 for the transfer of torque from the rotor shaft 2 to the rotor cup 1, and for the axial securing of the rotor cup 1 on the rotor shaft 2. Furthermore, the two parts 3, 5 of the coupling device 4 comprise centering means 7 for centering the rotor cup 1 on the rotor shaft 2.

In the present case, the first part 3 of the coupling device 4 of the rotor cup 1 contains a cone-shaped extension 8 and a securing element 13, in the present case an O-ring as a connecting means 6 on the rotor cup 1. The second part 5 of the coupling device 4 of the rotor shaft 2 comprises a cone-shaped receiver 10 along with a first circumferential groove 11 as a connecting means 6 on the rotor shaft 2. In the present case, the O-ring is arranged in a second circumferential groove 12 of the extension 8, but could also be arranged in the first circumferential groove 11 of the receiver 10. The two circumferential grooves 11, 12 are offset relative to one another in such a manner that the rotor cup 1 is pulled in an axial manner into the conical receiver 10 of the rotor shaft 2 if the rotor cup 1 and the rotor shaft 2 are connected to one another. Furthermore, it would also be conceivable for only one of the two parts (the receiver 10 or the extension 8) to feature a circumferential groove 11, 12. The extension 8 along with the corresponding receiver 10 of the rotor shaft 2 are, at the same time, formed as a centering means 7, in such a manner that the rotor cup 1 can be centered in the rotor shaft 2.

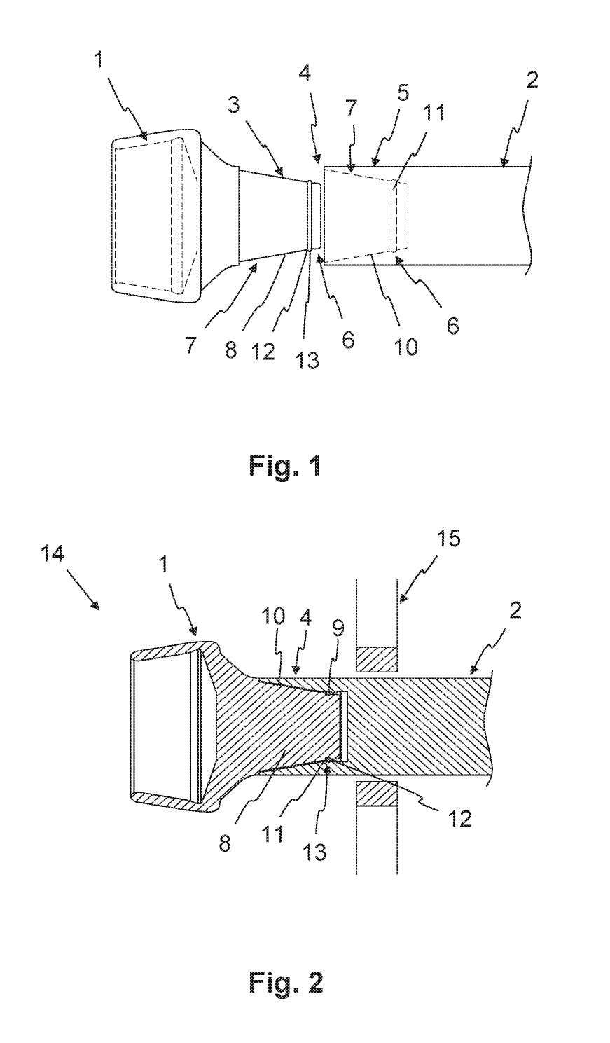

However, in the present case, as already described, the extension 8 also serves, at least partly, as a connecting means 6. The same applies to the receiver 10, which is described in the following with reference to FIG. 2. In the present case, the connecting means 6 is thus formed, at least partially, in one piece with the centering means 7. The O-ring forms a connecting means 6 for connecting the rotor cup 1 to the rotor shaft 2. According to the present illustration, the O-ring forms a securing element 13 for the axial securing of the rotor cup 1 on the rotor shaft 2. Moreover, the transfer of torque from the rotor shaft 2 to the rotor cup 1 takes place by means of the O-ring, if the rotor cup 1 is arranged in the rotor shaft 2 (see FIG. 2). Thus, the securing element 13, here in the form of the O-ring, at the same time serves as a connecting means 6 for axial securing and for the transfer of torque from the rotor shaft 2 to the rotor cup 1. Instead of an O-ring, the securing element 13 could also be formed as a snap ring.

Each of the extension 8 and the receiver 10 corresponding to the extension 8 features an angle of inclination of 10° to 30°. In the present case, the extension 8 is formed in one piece with the rotor cup 1, but could also be a separate component connected thereto.

FIG. 2 shows an open-end spinning rotor 14 in a sectional view. The open-end spinning rotor 14 is rotatably mounted in a bearing 15, and is preferably driven by an electric motor (not shown). The bearing 15 can be formed as a magnetic bearing or as a conventional bearing with supporting disks. The open-end spinning rotor 14 comprises the rotor cup 1 and the rotor shaft 2 in accordance with FIG. 1. The rotor cup 1 is connected to the rotor shaft 2, whereas the extension 8 of the rotor cup 1 is arranged in the receiver 10 of the rotor shaft 2. The securing element 13, here the O-ring 9, is initially arranged only in the second circumferential groove 12 of the extension 8, and is pressed into a first circumferential groove 11 of the receiver 10 during the assembly of the rotor cup 1 on the rotor shaft 2. The rotor cup 1 is thus pulled in an axial manner into the receiver 10 of the rotor shaft 2, and is thus secured in an axial manner at the rotor shaft 2. By means of the O-ring 9, a force-fitting connection is produced between the rotor shaft 2 and the rotor cup 1, which, during operation of the spinning rotor 14, transfers the torque from the rotor shaft 2 to the rotor cup 1. This would also be possible if the securing element 13 were formed as a snap ring.

With the following description of the additional figures, the same reference signs are used for characteristics that have already been described in connection with FIGS. 1 and 2 or with another figure, and that are identical and/or at least comparable in their arrangement and/or modes of action. To the extent that they are not explained again in detail, their arrangement and/or modes of action correspond to the arrangement and modes of action of the characteristics already described in connection with other figures. Moreover, for reasons of clarity, all characteristics are not provided with reference signs in all figures.

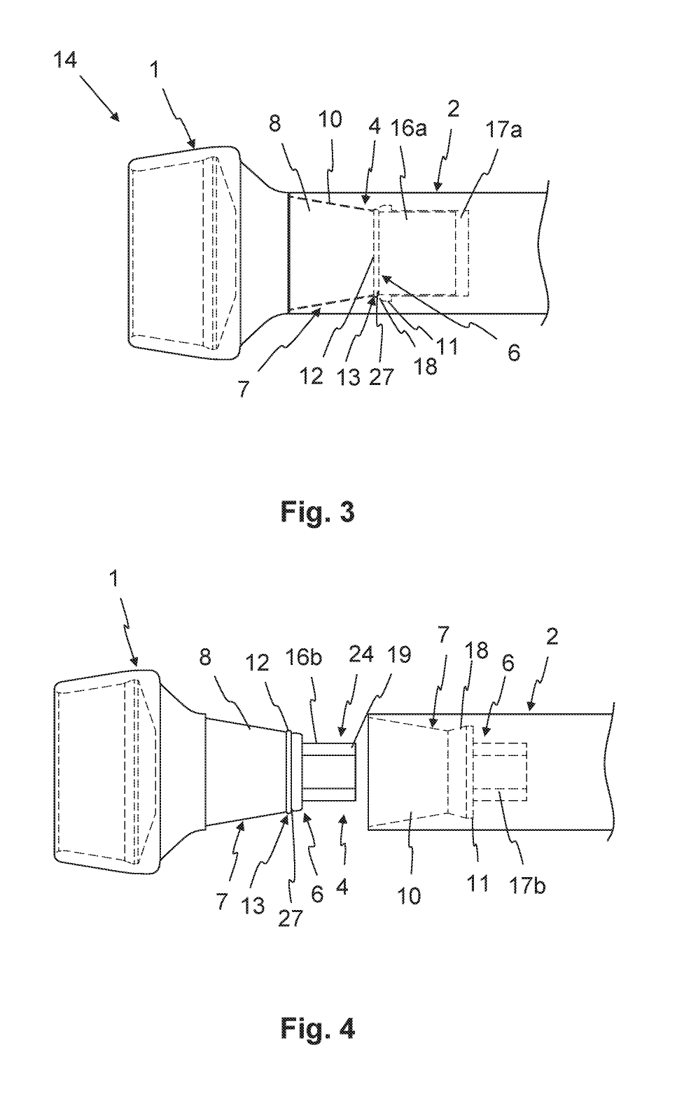

FIG. 3 shows the open-end spinning rotor 14 with an alternative design of the rotor cup 1 and the rotor shaft 2 provided for it. The rotor cup 1 is once again formed in one piece with the extension 8 and essentially corresponds to that of FIGS. 1 and 2, whereas, however, in contrast to FIGS. 1 and 2, a cylindrical attachment 16a is arranged on the extension 8. The cylindrical attachment 16a essentially extends the extension 8. The rotor shaft 2 features a cylindrical recess 17a corresponding to the attachment 16a. The extension 8 and the receiver 10 are formed to have a cone shape. The attachment 16a and the recess 17a are cylindrical and serve the purpose of better guidance of the rotor cup 1 on the rotor shaft 2, but the centering takes place through the conical seat between the receiver 10 and the extension 8. The receiver 10 and the recess 17a are connected to one another essentially through a first circumferential groove 11 with an inclined groove flank 18. In the present case, a snap ring 27 is provided as the securing element 13, which is arranged in the second circumferential groove 12 of the extension 8. Upon the rotation of the rotor cup 1, the snap ring 27 cooperates with the inclined groove flank 18, such that the rotor cup is pulled into the rotor shaft. As described above with reference to FIGS. 1 and 2, the force closure acting through the securing element 13 provides for anti-rotation protection between the rotor shaft 2 and the rotor cup 1. If the rotor shaft 2 rotates, the rotor cup 1 consequently rotates together with the rotor shaft 2.

The inclined groove flank 18 is now arranged in such a manner that the securing element 13, in this case the snap ring 27, widens and presses against the groove flank 18 if the rotor cup 1 is connected to the rotor shaft 2 and circulates at high rotational speed during operation. As a result, the rotor cup 1 is pulled in an axial manner onto the rotor shaft 2, or in particular into the recess 17a, such that a particularly good connection is achieved between the rotor shaft 2 and the rotor cup 1. In doing so, such a circumferential groove 11 with an inclined groove flank 18 can be used both with a securing element 13, which serves only for axial securing, and, also with a securing element 13, which can serve the purpose of axial securing and the transfer of torque.

FIG. 4 shows a third design of the rotor cup 1 and the rotor shaft 2 provided for it. The rotor cup 1 and the rotor shaft 2 are shown separately and can be connected to an open-end spinning rotor 14 as described in FIG. 3. In the present case, in the second circumferential groove 12 of the extension 8, a snap ring 27 is arranged as a securing element 13 or as a connecting means 6 for an axial connection. The extension 8 has an edged attachment 16b, which is formed such that a torque-transferring surface 19 is provided. Thus, in the present case, the attachment 16b forms a form closure element 24 of the extension 8. In a manner corresponding to the edged attachment 16b of the rotor cup 1, an edged recess 17b of the rotor shaft 2 is formed; it also constitutes a form closure element 24. Thus, the attachment 16b and the recess 17b form connecting means 6 for the transfer of torque. In the present case, in the receiver 10 of the rotor shaft 2, a first circumferential groove 11 is formed once again for cooperation with the securing element 13 of the extension 8, which can feature an inclined groove flank 18 or can be formed as a simple groove with straight flanks. The cone-shaped receiver 10 and the cone-shaped extension 8 are provided as the centering means.

By way of derogation from that shown in FIGS. 1 to 4, it would, of course, also be possible to provide the extension 8 on the rotor shaft 2 and the receiver 10 on the rotor cup 2. Furthermore, the groove 11 of the receiver 10 can also be formed with or without an inclined groove flank 18.

An additional embodiment (not shown) is described below on the basis of FIGS. 3 and 4. With this, a cone-shaped extension 8 in accordance with the preceding description is formed on the rotor shaft 2, and the rotor cup 1 features the cone-shaped receiver 10. On the cone-shaped extension 8 of the rotor shaft 2, the securing element 13, in particular an O-ring 9 or a snap ring 27, is provided in the second circumferential groove 12 of the extension 8. As described above, upon the connection of the rotor shaft 2 to the rotor cup 1, the snap ring 27 is then pressed against an inclined groove flank 18 of the receiver 10 of the rotor cup 1, by which an axial securing of the rotor cup 1 on the rotor shaft is achieved. The inclined groove flank 18 can be formed with a circumferential groove 11.

However, by way of derogation from the illustration of FIGS. 3 and 4, the cone-shaped extension 8 does not feature a cylindrical attachment 16a or an edged attachment 16b; rather, it features a likewise conical attachment or extension, which is provided with a knurling or toothing as a form closure element 24. In the rotor shaft 2, a corresponding recess 17, which is likewise conical and likewise features a knurling or toothing, is provided in the extension of the receiver 10. The receiver 10 with the recess 17 can also be provided by a separate component in the form of an insert, which can be inserted into a bore of the rotor shaft 2. In order not to impair the centering in the area of the extension 8 and the receiver 10, the form closure elements 24 can be provided with a clearance in the radial direction.

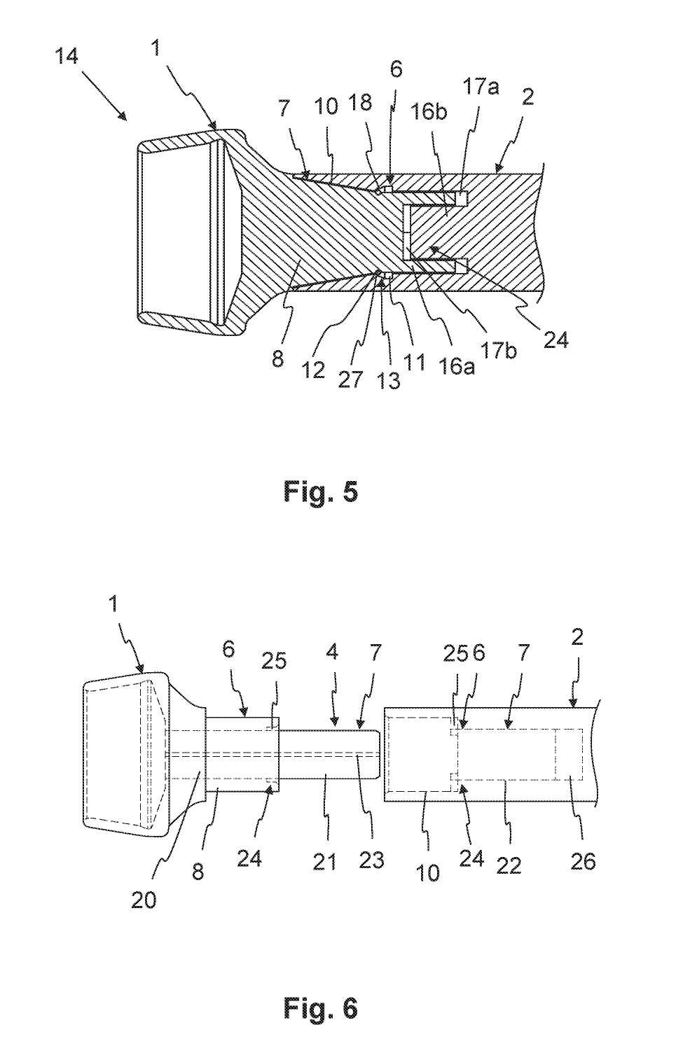

FIG. 5 shows a fourth embodiment of the rotor cup 1 and of the rotor shaft 2, whereas they are connected to the open-end spinning rotor 14. The rotor cup 1 features the extension 8 along with, as the securing element 13, the snap ring 27 arranged in the second circumferential groove 12. A cylindrical attachment 16a, in which the edged recess 17b is now formed, is formed on the extension 8. The rotor shaft 2 features the receiver 10 along with a cylindrical recess 17a, in which an edged attachment 16b corresponding to the edged recess 17a is formed. Thus, each of the edged attachment 16b and the edged recess 17b contains a form closure element 24 and in turn forms connecting means 6 for the transfer of torque.

The snap ring 27 and the groove flank 18, on the other hand, in turn constitute connecting means 6 for the axial securing of the rotor cup 1 on the rotor shaft 2. In addition, at least in part, a force-fitting transfer of torque between the rotor cup 1 and the rotor shank 2 can also be effected through the snap ring 27 and the groove flank 18.

The centering of the rotor cup 1 and the rotor shaft 2 is effected through the cooperation of the cone-shaped extension 8 and the cone-shaped receiver 10, on which, as described above, at least a part of the connecting means 6 is arranged, or at the same time at least a part of the connecting means 6 is presented. Consequently, the centering means 7 and the connecting means 6 are partially formed in one piece. Such commonality features the previously described embodiments 1 to 4.

FIG. 6 shows a fifth embodiment of the rotor cup 1 and of the rotor shaft 2 provided for it. With this, the centering means 7 comprise at least one centering element 20, which is formed separately from the connecting means 6. The centering element 20 comprises a cylinder pin 21, which in the present case is pressed into the rotor cup 1, in particular the extension 8. The cylinder pin 21 extends from the rotor cup 1 beyond the extension 8.

A centering bore 22 is arranged in the rotor shaft 2 as the centering means 7; it corresponds to the cylinder pin 21 of the rotor cup 1 and also forms a centering means 7. The cylinder pin 21 features a pressure compensation bore 23. The pressure compensation bore 23 extends from the cylinder pin 21 into the rotor cup 1, such that the air pressure is compensated upon the connection of the rotor cup 1 to the rotor shaft 2.

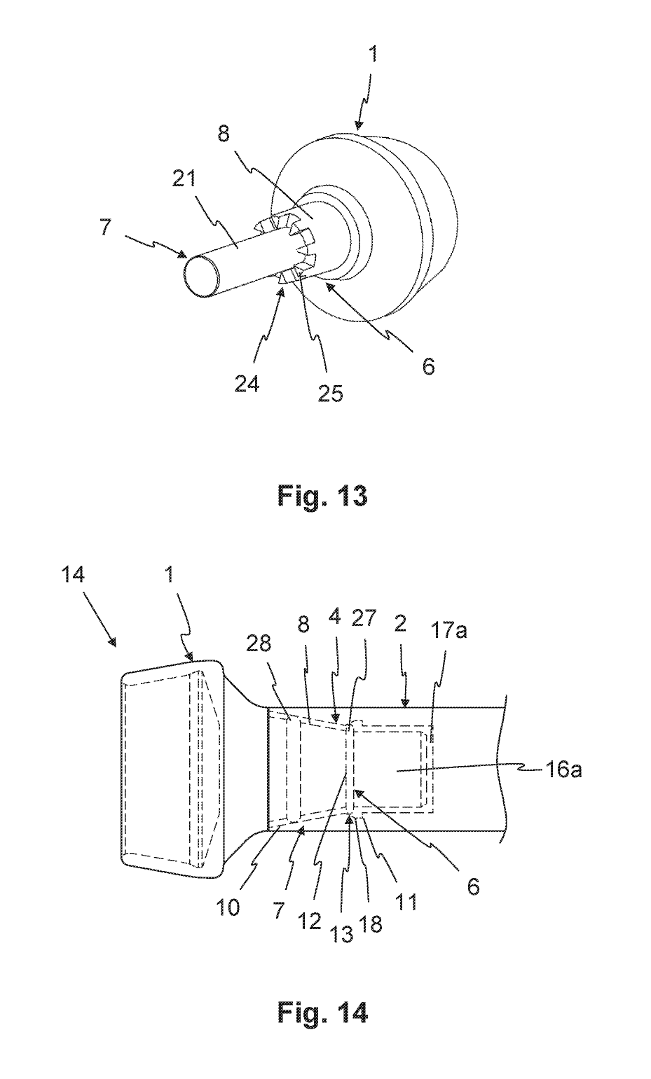

The coupling device 4 further comprises a form closure element 24 for the transfer of torque from the rotor shaft 2 to the rotor cup 1. In the present case, a part of a claw coupling 25 is provided as a form closure element 24 on the rotor cup 1 and also on the rotor shaft 2 corresponding to it. Thus, just like the edged recesses 17b or attachments 17a described above, the form closure elements 24 also form connecting means 6 for the transfer of torque. In the present case, a magnet 26 is provided in the rotor shaft 2 as a connecting means 6 for axial securing. The claw coupling 25 is shown in detail in FIG. 13.

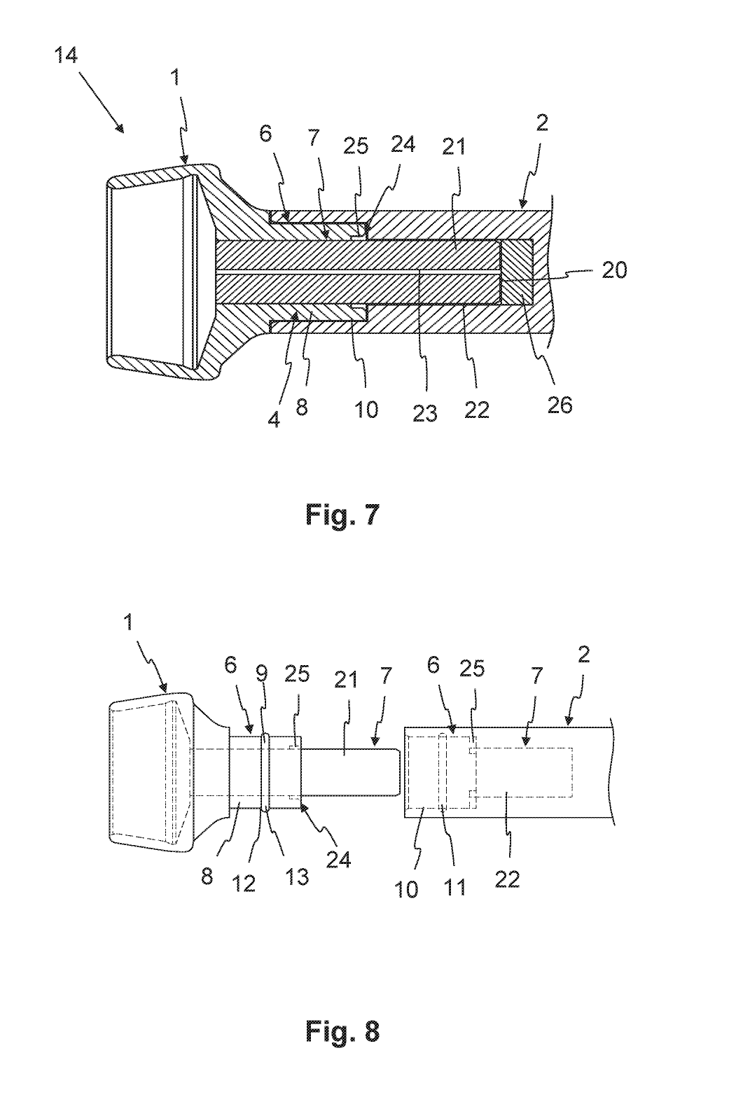

FIG. 7 shows the open-end spinning rotor 14 with the rotor cup 1 and the rotor shaft 2 in accordance with FIG. 6, in particular in accordance with the fifth embodiment. The rotor cup 1 is connected to the rotor shaft 2 by means of the connecting means 6. The connecting means 6 for the transfer of torque is formed by the form closure elements 24 arranged on the extension 8 and the receiver 10. The claw coupling 25 engages in such a manner that a transfer of torque can take place from the rotor shaft 2 to the rotor cup 1. The rotor cup 1 and the rotor shaft 2 are secured in an axial manner by means of a magnet 26 arranged in the rotor shaft 2, which thus forms a connecting means 6 for axial securing. The centering of the rotor cup 1 is effected by means of the cylinder pin 21 of the rotor cup 1, which is arranged in the centering bore 22 of the rotor shaft 2.

Thus, the centering element 20, in particular the cylinder pin 21, is formed completely separately from the connecting means 6, in particular from the form closure element 24 arranged on the extension 8 and the receiver 10 for the transfer of torque and the magnet 26 for axial securing.

FIG. 8 shows the rotor cup 1 along with the rotor shaft 2 provided for it in accordance with a sixth embodiment. The rotor cup 1 features the extension 8 with a part of a claw coupling 25, which is formed in a manner corresponding to a second part of the claw coupling 25 of the receiver 10 of the rotor shaft 2. Furthermore, the extension 8 features the second circumferential groove 12. A securing element 13, in particular the O-ring 9, is arranged in the second circumferential groove 12. The receiver 10 of the rotor shaft 2 features a first circumferential groove 11, into which the O-ring 9 is pressed if the rotor cup 1 and the rotor shaft 2 are connected to one another for forming the open-end spinning rotor 14. The axial securing of the rotor cup 1 on the rotor shaft 2 takes place through the O-ring 9 and the grooves 11, 12 as connecting means 6 for axial securing. The reliable transfer of torque is ensured by the coupled form closure elements 24, in particular the claw coupling 25, as connecting means 6. The centering of the rotor cup 1 on the rotor shaft 2 takes place by means of the cylinder pin 21 and the centering bore 22 as centering means 7, which is to receive the cylinder pin 21.

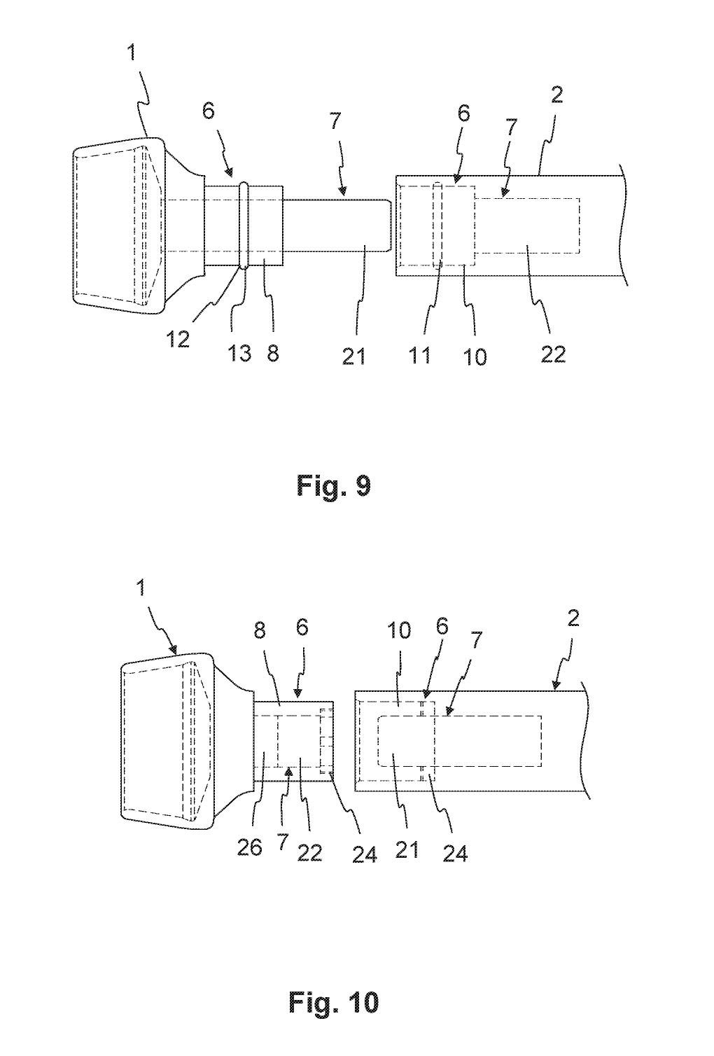

FIG. 9 shows a seventh embodiment of the rotor cup 1 and the rotor shaft 2. Contrary to the previously described embodiments, the rotor cup 1 does not feature a form closure element 24. The axial securing of the rotor cup 1 on the rotor shaft 2 takes place only by means of the O-ring 9 or another securing element 13 for axial securing which, in the connected state, is received by the first and second circumferential grooves 11, 12. The axial securing along with the transfer of torque is effected by means of the securing element 13, in particular the O-ring 9 or the snap ring 27 (see FIGS. 3 and 4), as connecting means 6.

The centering of the rotor cup 1 and of the rotor shaft 2 continues to be effected through the cylinder pin 21 and the corresponding centering bore 22 as the centering means 7. The snap ring 27 cooperates jointly with the inclined groove flank 18 in accordance with FIGS. 3 and 4. In each case, the embodiments that feature the first circumferential groove 11 and the second circumferential groove 12 can be modified to the effect that one of the circumferential grooves 11, 12 is replaced or supplemented by the inclined groove flank 18, such that cooperation with the snap ring 27 can be realized. At this, in the snap ring 27 is arranged in the remaining first or second circumferential groove 11, 12.

FIG. 10 shows an eighth embodiment of the rotor cup 1 and of the rotor shaft 2. The rotor cup 1 features the extension 8, in which the centering bore 22 is formed. Furthermore, the extension 8 features the form closure element 24 as a connecting element 6 for the transfer of torque. Furthermore, a magnet 26 is arranged in the rotor cup 1 as a connecting element 6 for an axial connection. The rotor shaft 2 comprises the receiver 10, whereas the cylinder pin 21 is formed in the receiver 10. In addition, the form closure element 24 is arranged in the receiver 10.

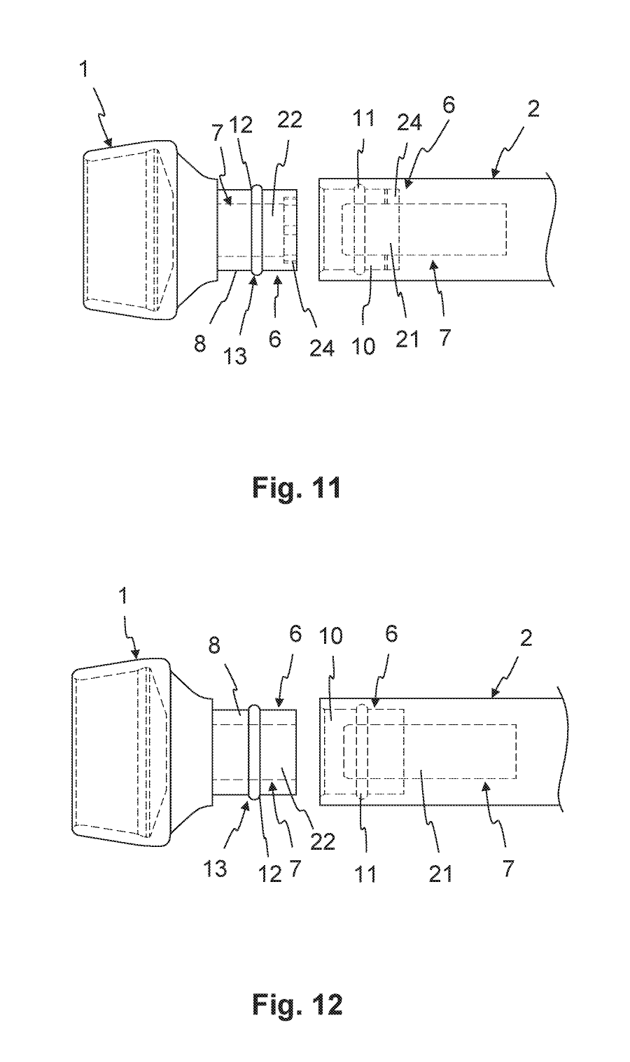

FIG. 11 shows a ninth embodiment of the rotor cup 1 and of the rotor shaft 2. On the rotor shaft 2 and the rotor cup 1, in addition to the form closure element 24 as a connecting element for the transfer of torque, a securing element 13, in particular an O-ring 9 or a snap ring 27, is arranged as a connecting element 6 for an axial connection. The centering is once again effected by means of separate centering means 7, namely the cylinder pin 21 and the centering bore 22.

FIG. 12 shows a tenth embodiment of the rotor cup 1 and of the rotor shaft 2. The axial securing of the rotor cup 1 on the rotor shaft 2 and the transfer of torque from the rotor shaft 2 to the rotor cup 1 are solely effected by means of the securing element 13, in particular the O-ring 9, as connecting means 6. The cylinder pin 21, which is inserted into the centering bore 22 for connecting the rotor shaft 2 to the rotor cup 1, is arranged in the rotor shaft 2. The centering of the rotor cup 1 and of the rotor shaft is effected by means of the cylinder pin 21 and the centering bore 22.

FIG. 13 shows the rotor cup 1, which carries the claw coupling 25 in the form of a toothing. Furthermore, the rotor cup 1 features the cylindrical extension 8 along with the cylinder pin 21 pressed therein, in accordance with FIG. 6. The claw coupling 25 is formed as a form closure element 24, by means of which the rotor cup 1 can be connected in a torque-proof manner to the rotor shaft 2 in accordance with FIG. 6. The rotor shaft 2 features a toothing corresponding to the claw coupling 25.

FIG. 14 finally shows an additional embodiment of the rotor cup 1 and the rotor shaft 2 provided for it. The open-end spinning rotor 14 of FIG. 14 essentially corresponds to that of FIG. 3, such that, in the following, only the differences with the design of FIG. 3 are described. As can be seen in FIG. 14, the cone-shaped extension 8 of the rotor cup 1 herein features, close to the beginning of the extension 8, a circumferential elevation 28, which in the present case is designed as a round bulge. As a result, a defined contact area can be provided between the cone-shaped extension 8 and the cone-shaped receiver 10 of the rotor shaft 2. Thereby, the support of the rotor cup 1 in the rotor shaft 2 can be improved even if, as in the present case, only a small axial clamping force can be applied through the axial securing element 13. The securing element 13 can be designed as a snap ring 27 or even as an elastic O-ring, which in turn, pulls the rotor cup in an axial manner into the rotor shaft 2 through the circumferential groove 11 with the inclined groove flank 18, and at the same time forms anti-rotation protection between the rotor shaft 2 and the rotor cup 1. Of course, the elevation 28 can also be formed by a circumferential elevation 28, which is rectangular or trapezoidal in the cross-section, instead of a round bulge or instead of a half-round profile.

This invention is not limited to the illustrated and described embodiments. Variations within the scope of the claims, just as the combination of characteristics, are possible, even if they are illustrated and described in different embodiments.

LIST OF REFERENCE SIGNS

1 Rotor cup

2 Rotor shaft

3 First part of a coupling device

4 Coupling device

5 Second part of a coupling device

6 Connecting means

7 Centering means

8 Extension

9 O-ring

10 Receiver

11 First circumferential groove

12 Second circumferential groove

13 Securing element

14 Open-end spinning rotor

15 Bearing

16a Cylindrical attachment

16b Edged attachment

17a Cylindrical recess

17b Edged recess

18 Groove flank

19 Torque-transferring surface

20 Centering element

21 Cylinder pin

22 Centering bore

23 Pressure compensation bore

24 Form closure element

25 Claw coupling

26 Magnet

27 Snap ring

28 Elevation

1-16. (canceled)

17. A rotor cup for spinning a fiber material, comprising:
a coupling device to detachably connect the rotor cup to a rotor shaft;
the coupling device comprising at least one connecting means for transfer of torque from the rotor shaft to the rotor cup and for axial securing of the rotor cup on the rotor shaft;
the coupling device comprising at least one centering means for centering the rotor cup on the rotor shaft;
the rotor cup comprising an extension extending therefrom;
wherein
the centering means comprises the extension formed as a cone-shaped extension or a cone-shaped receiver defined on the rotor cup that receives a correspondingly shaped member of the rotor shaft; or
the connecting means comprises the extension on the rotor cup and the centering means comprises a centering element separate from the connecting means and comprising one of a cylinder pin fixed in the rotor cup or a centering bore arranged in the rotor cup.

18. The rotor cup according to claim 17, wherein the extension further comprises a rotationally symmetrical attachment extending from the extension that is configured to be received in a correspondingly shaped recess in the rotor shaft.

19. The rotor cup according to claim 18, wherein the extension further comprises a ring-shaped circumferential elevation arranged in an area of the extension closer to the rotor cup than to the attachment.

20. The rotor cup according to claim 17, wherein the connecting means is formed at least partially in one piece with the centering means.

21. The rotor cup according to claim 17, wherein the extension is formed in one piece with the rotor cup.

22. The rotor cup according to claim 17, wherein the cylinder pin is fixed into the rotor cup and further comprises a pressure compensation bore.

23. The rotor cup according to claim 17, wherein the cone-shaped receiver comprises a first circumferential groove or the cone-shaped extension comprises a second circumferential groove, and the connecting means comprises a securing element inserted into the first circumferential groove of the receiver or into the second circumferential groove of the extension for the axial securing of the rotor cup on the rotor shaft.

24. The rotor cup according to claim 23, wherein the first circumferential groove of the receiver comprises an inclined groove flank.

25. The rotor cup according to claim 23, wherein the securing element also serves to transfer the torque from the rotor shaft to the rotor cup.

26. The rotor cup according to claim 17, wherein the extension or the receiver on the rotor cup further comprises a form closure element that forms a positive-locking connection with the rotor shaft for the transfer of torque from the rotor shaft to the rotor cup.

27. The rotor cup according to claim 17, wherein the cone-shaped extension further comprises a rotationally symmetrical attachment extending from the cone-shaped extension or the cone-shaped recess receiver comprises a rotationally symmetrical recess, and further comprising a form closure element arranged on the attachment or in the recess for the transfer of torque from the rotor shaft to the rotor cup.

28. An open-end spinning rotor, comprising:
a rotor cup in which a fiber material is spun;
the rotor cup comprising an extension extending therefrom;
a rotor shaft detachably connected with the rotor cup via coupling device, the rotor shaft providing for support of the spinning rotor in a bearing;
the coupling device further comprising:
a connecting means for transfer of torque from the rotor shaft to the rotor cup and for axial securing of the rotor cup on the rotor shaft;
a centering means for centering the rotor cup on the rotor shaft;
wherein
the centering means comprises the extension formed as a cone-shaped extension or a cone-shaped receiver defined on the rotor cup that receives a correspondingly shaped member of the rotor shaft;
or
the centering means comprises a centering element separate from the connecting means, the centering element comprising a cylinder pin fixed into one of the rotor cup or the rotor shaft, the cylinder pin detachably inserted into a centering bore defined in the other of the rotor shaft or the rotor cup, and the connecting means comprising an extension on the rotor cup that is insertable into a receiver on the rotor shaft.

29. The open-end spinning rotor according to claim 28, wherein the centering means comprises a rotationally symmetrical attachment, and the receiver comprises a correspondingly shaped rotationally symmetrical recess.

30. The open-end spinning rotor according to claim 28, wherein the cylinder pin is fixed into the rotor shaft.

31. The open-end spinning rotor according to claim 28, wherein the connecting means is formed at least partially in one piece with the centering means.
